(19) United States
(12) Patent Application Publication
(10) Pub. No.: US 2025/0220515 A1
(43) Pub. Date: Jul. 3, 2025

(54) CLIENT DRIVEN SEMI-HITLESS ROAMING

(71) Applicant: Cisco Technology, Inc., San Jose, CA (US)

(72) Inventors: Sudhir Kumar Jain, Fremont, CA (US); Brian Donald Hart, Sunnyvale, CA (US); Malcolm Muir Smith, Richardson, TX (US)

(21) Appl. No.: 18/795,019

(22) Filed: Aug. 5, 2024

Related U.S. Application Data
(60) Provisional application No. 63/615,713, filed on Dec. 28, 2023.

(51) Int. Cl. H04W 36/00

(52) U.S. Cl. CPC H04W 36/0055; H04W 36/0069

(57) ABSTRACT

Aspects of the present disclosure are directed to techniques for a light-weight roaming protocol in a Multi-Link Operation wireless network. In one aspect, a method includes detecting a roaming point, wherein the roaming point is an event that triggers a user equipment to switch connectivity from a first access point to a second access point, and the user equipment, the first access point, and the second access point operate as multi-link devices. The method further includes maintaining, by the first access point, transmission of downlink data to the user equipment after the roaming point until one of a plurality of conditions occurs; and discarding uplink traffic from the user equipment.

### CROSS-REFERENCE TO RELATED APPLICATIONS

This application claims priority from U.S. Provisional Application No. 63/615,713 filed on Dec. 28, 2023, the contents of which in its entirety are herein incorporated by reference.

### TECHNICAL FIELD

The present disclosure relates to wireless communication systems operating using Multi-Link Operation technology, and in particular to providing a lightweight roaming protocol for Wi-Fi 8 technology.

### BACKGROUND

Multi-Link Operation (MLO) is a Wi-Fi technology that enables devices connected to a Wi-Fi access point (AP) to simultaneously send and/or receive data across different frequency bands and channels. In MLO, links can be added and deleted dynamically.

Wi-Fi 8 is the next generation of Wi-Fi technology that enhances the MLO capabilities. Furthermore, when a Wi-Fi 8 client moves around, the client should be connected to the nearest AP. Roaming from one AP to the next can result in reduce connectivity during roaming.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows a pictorial diagram of an example wireless communication network according to some aspects of the present technology;

FIG. 2A illustrates an example of a wireless communication network spanning a single floor of a building;

FIG. 2B depicts an illustrative schematic diagram for connectivity of an AP multi-link device (MLD) with multiple affiliated Aps to a non-AP MLD with multiple affiliated non-AP STAs according to some aspects of the present disclosure;

FIG. 3 illustrates an example roaming scenario for a MLD switching connectivity from a current AP-MLD to a target AP-MLD, according to some aspects of the present disclosure;

FIG. 4A illustrates an example process implemented based on the proposed roaming protocol described above, according to some aspects of the present disclosure;

FIG. 4B illustrates an example process implemented based on the proposed roaming protocol described above, according to some aspects of the present disclosure; and

FIG. 5 shows an example of a system for implementing certain aspects of the present technology, according to some aspects of the present disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Aspects of the present disclosure are directed to techniques for a light-weight roaming protocol that enables a Multi-Link Device (MLD) to switch roaming from one Access Point MLD (AP-MLD) to another AP-MLD whereby transferring of device state from one AP-MLD to the next is minimized and some aspects of state transfer management during the handover process are handled by the MLD devices themselves.

In one aspect, a method includes detecting a roaming point, wherein the roaming point is an event that triggers a user equipment to switch connectivity from a first access point to a second access point, and the user equipment, the first access point, and the second access point operate as multi-link devices. The method further includes maintaining, by the first access point, transmission of downlink data to the user equipment after the roaming point until one of a plurality of conditions occurs; and discarding uplink traffic from the user equipment.

In another aspect, the method further includes discarding uplink state information for the user equipment.

In another aspect, the method further includes transferring network control information from the first access point to the second access point at the roaming point.

In another aspect, the network control information includes a sequence number counter and a packet number counter for queued data units at the first access point, a rate limiting state information, and a replay detection state information.

In another aspect, the plurality of conditions include: receiving a notification from the user equipment that the user equipment has switched connectivity from the first access point to the second access point; a timeout at the first access point that is longer than a threshold period; receiving a notification from the second access point that the second access point has sent most or all of sequence number space to the user equipment for a traffic identifier; and reporting, by the second access point, that the user equipment has roamed to a new access point that is different from the first access point or the second access point.

In another aspect, the method further includes flushing, prior to the roaming point, a reorder buffer of the first access point to a network controller of a network in which the user equipment, the first access point, and the second access point operate.

In another aspect, the method further includes prior to the roaming point, incrementing a sequence number counter and a packet number counter for queued data units at the first access point; and sending the sequence number counter and the packet number counter to the second access point after the incrementing.

In one aspect, an access point includes one or more memories having computer-readable instructions stored therein, and one or more processors. The one or more processors are configured to execute the computer-readable instructions to detect a roaming point, wherein the access point is a first access point, the roaming point is an event that triggers a user equipment to switch connectivity from the first access point to a second access point, and the user equipment, the first access point, and the second access point operate as multi-link device. The one or more processors are further configured to maintain, by the first access point, transmission of downlink data to the user equipment after the roaming point until one of a plurality of conditions occurs; and discard uplink traffic from the user equipment.

In one aspect, one or more non-transitory computer-readable media include computer-readable instructions, which when executed by one or more processors of an access point, cause the access point to detect a roaming point, wherein the access point is a first access point, the roaming point is an event that triggers a user equipment to switch connectivity from the first access point to a second access point, and the user equipment, the first access point, and the second access point operate as multi-link devices. The execution of the computer-readable instructions further cause the first access point to maintain, by the first access point, transmission of downlink data to the user equipment after the roaming point until one of a plurality of conditions occurs; and discard uplink traffic from the user equipment.

### Example Embodiments

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every 5 years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency. The next expected update to IEEE 802.11 is coined as Wi-Fi 8. Wi-Fi 8 will attempt to further enhance throughput and minimize latency to meet the ever growing demand for the Internet of Things (IoT), high resolution video streaming, low-latency wireless services, etc.

Multiple Access Point coordination and transmission in Wi-Fi refers to the management of multiple access points in a wireless network to avoid interference and ensure efficient communication between the client devices and the network. When multiple access points are deployed in a network—for instance in buildings and office complexes-they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links. STAs may also be referred to as non-AP devices.

A multi-link device (MLD) may have several “affiliated” devices, each affiliated device having a separate PHY interface, and the MLD having a single link to the Logical Link Control (LLC) layer. In the proposed IEEE 802.11 be draft, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed or new mechanisms may be introduced to share the MLO information (e.g. related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features proposed to improve the performance of Wi-Fi networks in the upcoming IEEE 802.11 be amendment. Multi-AP coordination is directed toward utilizing (distributed) coordination between different APs to reduce inter-Basic Service Set (BSS) interference for improved spectrum utilization in dense deployments. MLO, on the other hand, supports high data rates and low latency by leveraging flexible resource utilization offered by the use of multiple links for the same device.

As a Wi-Fi device (e.g., a STA-MLD) moves around (roams), the device should be connected to a close (e.g., closest) AP-MLD device. In practice, connectivity during roaming is reduced since a) wireless activities should be completed such as association, 4 way handshake (saved by IEEE 802.11r, which may be known as Fast Transition (FT)), Block Acknowledgement (BA) agreement setup etc.; and b) infrastructure activities should be completed first such as L2 MAC address learning. Furthermore, any traffic buffered at the currently-serving AP MLD should be transferred to the target AP MLD. However, such transfer is often not completed due to complexities, delays, etc., This delay and packet loss causes disruption during roaming. This delay is not acceptable as Wi-Fi competes with 5G and aims adoption in high reliability (UHR) applications such as Augmented Reality/Virtual Reality, automated manufacturing. Etc. Therefore, Wi-Fi Ultra High Reliability (UHR) needs to provide improved roaming. This improved roaming may result in what is known as “Make Before Break” Roaming and/or Semi-Hitless Roaming.

Aspects of the present disclosure are directed to providing such needed improvement by presenting techniques for a light-weight roaming protocol that enables a STA-MLD to switch roaming from one AP-MLD (current AP-MLD) to another AP-MLD (target AP-MLD), whereby transferring of device state from current AP-MLD to target AP-MLD is minimized and some aspects of state transfer management from current AP-MLD to target AP-MLD during the handover process are handled by STA-MLDs themselves.

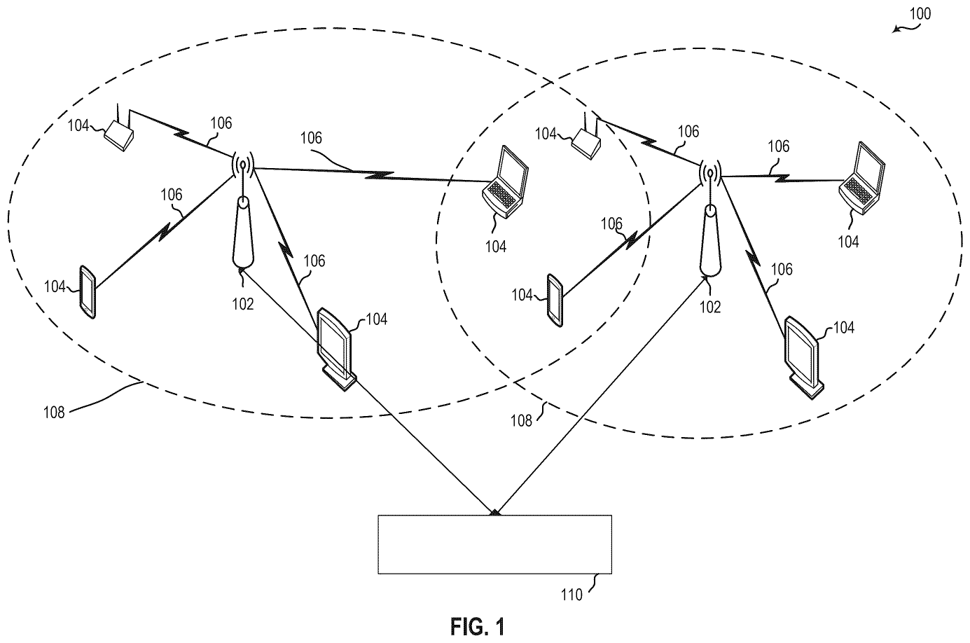

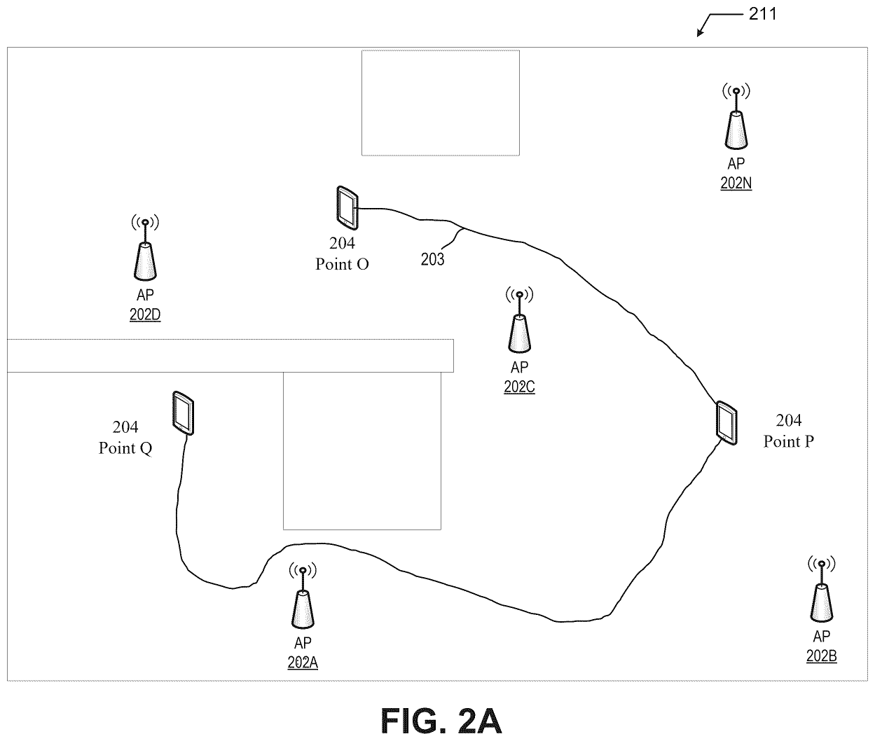

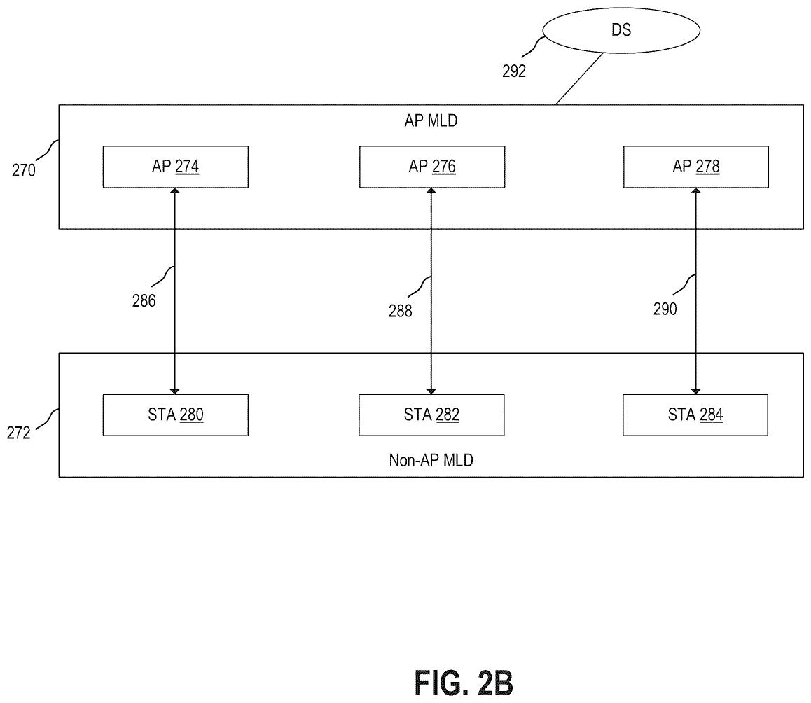

First, example network and structures for wireless communication and MLO operations are described with reference to FIGS. 1 and 2A-B.

FIG. 1 illustrates a block diagram of an example wireless communication network 100. According to some aspects, the wireless communication network 100 may be an example of a wireless local area network (WLAN) such as a Wi-Fi network (and will hereinafter be referred to as WLAN 100). For example, the WLAN 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the WLAN 100 may implement future versions and amendments of the wireless communication protocol standards and amendments thereof such as 802.11bn and be modified according to the present disclosure to include the features contained herein. The WLAN 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more STA actors 104, which can be one or more of a non-MLD STA, a STA affiliated with a non-AP MLD, and/or a non-AP MLD. As illustrated, the WLAN 100 also may include multiple AP actors 102. The multiple AP actors 102 can be coupled to one another through a switch 110. While the multiple AP actors 102 are shown as being coupled to one another through a switch 110, the network can provide another device that allows the coupling of the multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

A single AP actor 102 and an associated set of STA actors 104 may be referred to as a basic service set (BSS), which is managed by the respective AP 102. FIG. 1 additionally shows an example coverage areas 108 of the associated AP 102, which may represent a basic service area (BSA) of the WLAN 100. As illustrated, three of the STA actors 104 are within the BSA of each of the AP actors 102. The BSS may be identified to users by a service set identifier (SSID), where the BSS might be one of many in the SSID. The BSS may be identified to other devices by a unique (or substantially unique) basic service set identifier (BSSID). The AP 102 periodically broadcasts beacon frames (“beacons”) including the BSSID to enable STA actors 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons may include an identification of a primary channel used by the respective AP 102 as well as a timing synchronization function for establishing or maintaining timing synchronization with the AP 102. The AP 102 may provide communication links 106 to the various STA actors 104 and therefore access to external networks. While the example has been described in regards to an AP 102 and STA actors 104, the present disclosure extends such that an AP actor may provide access to external networks to various STA actors in a WLAN via respective communication links 106.

To establish a communication link 106 with an AP 102, each of the STA actors 104 is configured to perform passive or active scanning operations (“scans”) on frequency channels in one or more frequency bands (for example, the 2.4 GHz, 5 GHZ, 6 GHz or 60 GHz bands). To perform passive scanning, a STA actor 104 listens for beacons, which are transmitted by respective AP 102 at or near a periodic time referred to as the target beacon transmission time (TBTT) (measured in time units (TUs) where one TU may be equal to 1024 microseconds (μs)). To perform active scanning, a STA actor 104 generates and sequentially transmits probe requests on each channel to be scanned and listens for probe responses from AP 102. Each STA actor 104 may be configured to identify or select an AP and thence an AP 102 with which to associate based on the scanning information obtained through the passive or active scans, and to perform authentication and association operations to establish a communication link 106 with the selected AP 102. The AP 102 assigns an association identifier (AID) to the STA actor 104 at the culmination of the association operations, which the AP 102 uses to improve the efficiency of certain signaling to the STA actor 104.

The present disclosure modified the WLAN radio and baseband protocols for the PHY and medium access controller (MAC) layers. The AP 102 and STA actors 104 transmit and receive wireless communications (hereinafter also referred to as “Wi-Fi communications”) to and from one another in the form of PHY protocol data units (PPDUs). The AP 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

FIG. 2A illustrates an example a single floor 211 of building. While only a single floor is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 211 includes a plurality of AP actors 202A, 202B, 202C, 202D, 202N. Each of the AP actors 202A, 202B, 202C, 202D, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of one AP actor 202A, 202B, 202C, 202D, 202N may substantially overlap with the coverage of another of the AP actors 202A, 202B, 202C, 202D, 202N.

As illustrated by the line 203, STA actor 204 (may also be referred to as a UE) can move from point O to point P to point Q. When a STA actor 204 is moving around on a given floor, different AP actors 202A, 202B, 202C, 202D, 202N can be considered to be nearest to the STA actor 204. Nearest as used in relation to the AP actors 202A, 202B, 202C, 202D, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a non-AP MLD with affiliated logical entities according to some aspects of the present disclosure.

Referring to FIG. 2B, two multi-link logical entities AP MLD 270 and Non-AP MLD 272 are shown. AP MLD 270 may include physical (and/or logical) affiliated APs 274, 276, and 278 operating in different channels and typically different frequency bands (e.g., 2.4 GHZ, 5 GHz, and 6 GHZ). Affiliated APs 274, 276, and 278 may be the same as or similar to any one of the APs described above. Non-AP MLD 272 may include STAs 280, 282, and 284, which may be the same as or similar to any of the STAs as described herein.

Affiliated AP 274 may communicate with affiliated STA 280 via link 286. Affiliated AP 276 may communicate with affiliated STA 282 via link 288. Affiliated AP 278 may communicate with affiliated STA 284 via link 290.

AP MLD 270 is shown in FIG. 2B to have access to a distribution system (DS) 292, which is a system used to interconnect a set of BSSs to create an extended service set (ESS).

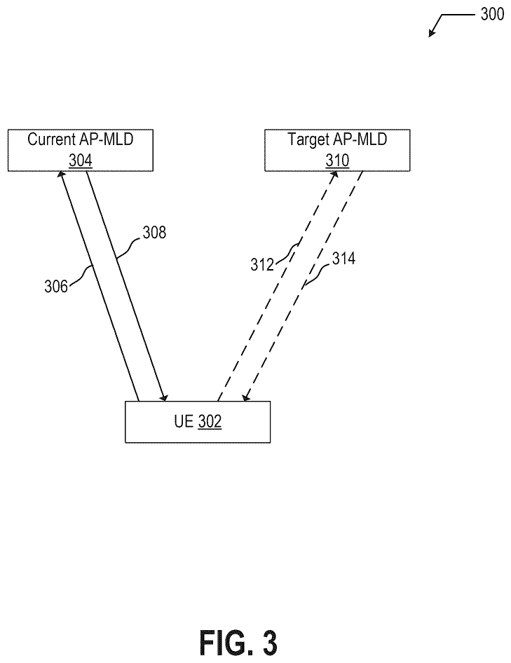

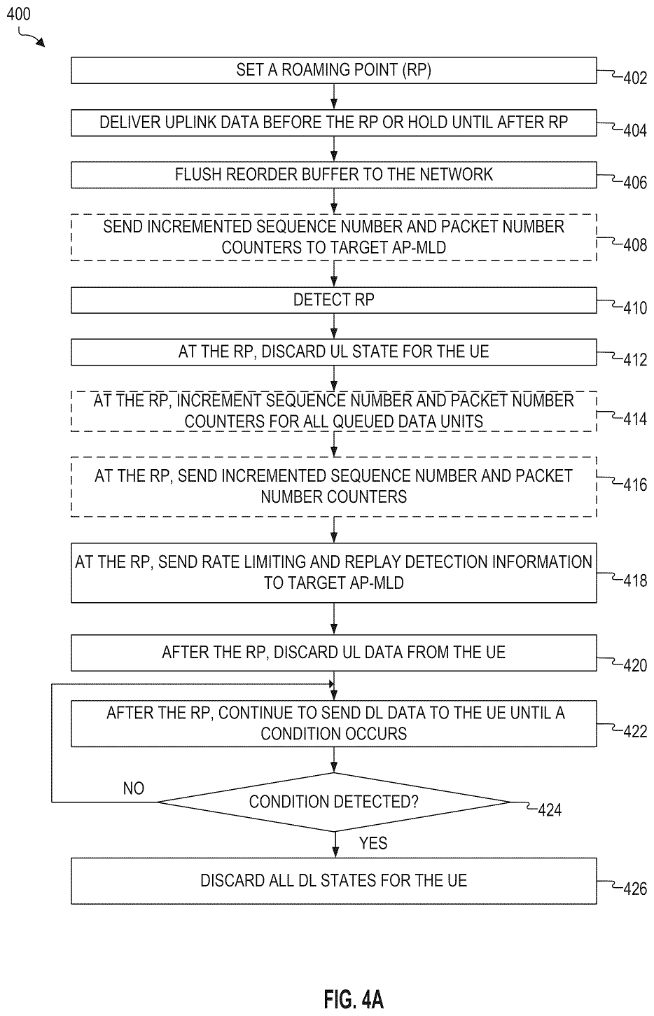

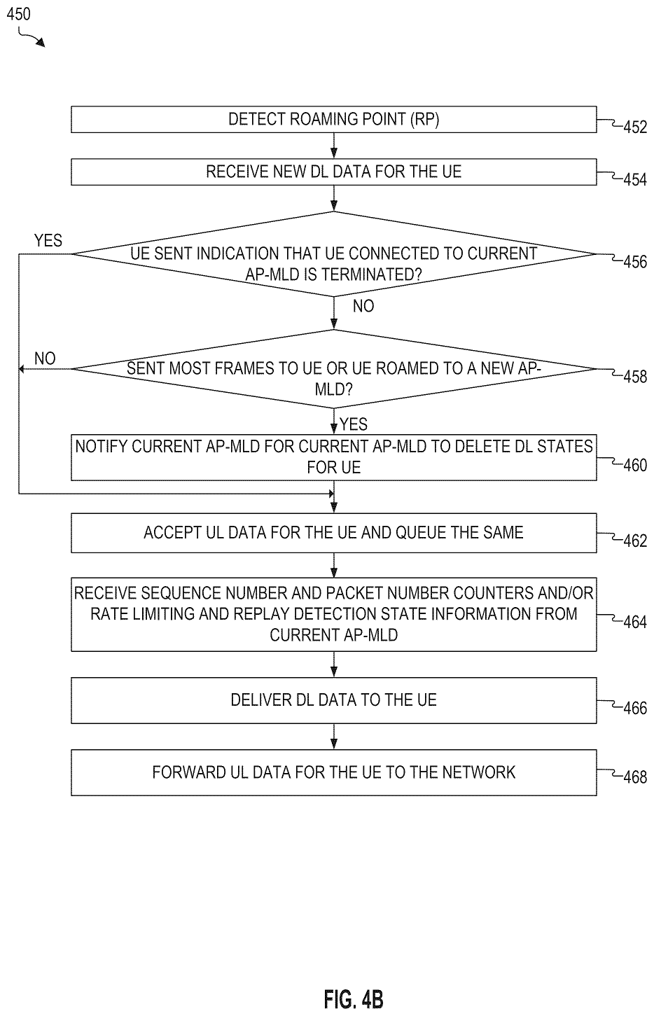

It should be understood that although the example shows three logical entities within the AP MLD and the three logical entities within the non-AP MLD, this is merely for illustration purposes and that other numbers of logical entities within each of the AP MLD and non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4A-B, and 5.

Hereinafter, example aspects of light-weight roaming protocol of the present disclosure will be described. FIG. 3 illustrates an example roaming scenario for a MLD switching connectivity from a current AP-MLD to a target AP-MLD, according to some aspects of the present disclosure.

In example scenario 300 of FIG. 3, a user equipment (UE) 302 can be a non-AP MLD (STA-MLD) such as STA actor 204, STA 280, STA 282, and/or STA 284. UE 302 may be connected to a current AP-MLD 304 (e.g., any one of AP 202A-N described with reference to FIG. 2A, affiliated APs 274, 276, and/or 278). FIG. 3 illustrates that UE 302 may have an uplink (UL) 306 to current AP-MLD 304 for UL data exchange from UE 302 to current AP-MLD 304. Similarly, UE 302 may have a downlink (DL) 308 to current AP-MLD 304 for DL data (traffic) exchange from current AP-MLD 304 to UE 302.

FIG. 3 further shows a target AP-MLD 310, which UE 302 may switch to upon occurrence of a roaming point (may also be referred to as a roam point), defined below. Target AP-MLD 310 can be any one of AP 202A-N described with reference to FIG. 2A, affiliated APs 274, 276, and/or 278. UE 302 may have UL 312 and DL 314 for UL and DL communications with target AP-MLD 310 similar to UL 306 and DL 308 described above. UL 312 and DL 314 are shown using dashed-lines to indicate that UE 302 is currently communicating with current AP-MLD 304 but is in the process of switching connectivity to target AP-MLD 310.

As noted above, roaming of UE 302 on a new AP (switching connectivity from current AP-MLD 304 to target AP-MLD 310) may occur at a Roaming Point (RP). A RP may be defined as a point in time, a location, and/or a condition within an MLO wireless network where a UE transitions connectivity from a current AP-MLD to a target AP-MLD.

A RP may be a pre-configured event such as for example, when a UE's distance exceeds a threshold distance of a current AP-MLD but is less than a threshold of a target AP-MLD. Another example event may be a threshold load on a current AP-MLD, etc. Various thresholds and/or events may be configurable parameters that may be determined based on experiments and/or empirical studies.

In some examples, a RP may be negotiated between a given UE (e.g., UE 302) and current AP-MLD 304.

In describing the disclosed roaming protocols, references may be made to three instances, namely, immediately before a RP, at the RP (when RP occurs), and after the RP.

As noted above, UE 302 may have UL data and/or DL data exchanged with current AP-MLD 304 during its connectivity to current AP-MLD 304. This exchange can occur via a corresponding one of UL 306 and DL 308.

Before occurrence of a RP, UE 302 may ensure that all UL traffic from UE 302 to current AP-MLD 304 are delivered and completed. Alternatively, UE 302 may ensure that UL traffic is held until transition of UE 302 from current AP-MLD 304 to target AP-MLD 310 is completed, at which point UL traffic for UE 302 may be sent to target AP-MLD 310 via UL 312. In some examples, this may occur well in advance (e.g., 5-10 seconds, 10-30 seconds, 30 seconds-1 minute, etc.) of occurrence of a RP.

In addition, before occurrence of a RP, current AP-MLD 304 may ensure that reorder buffer of current AP-MLD 304 is flushed.

At RP, current AP-MLD 304 may perform the following:

First, current AP-MLD 304 may discard all UL state for UE 302.

Second, at RP, AP-MLD 304 may increment sequence number (SN) counter and packet number (PN) counter sufficiently for all queued MAC Service Data Units (MSDUs), Aggregate MSDUs (A-MSDUs), and/or MAC Protocol Data Units (MPDUs) at current AP-MLD 304. MSDUs, A-MSDUs, and MPDUs are different types of frames used for data transmission within a wireless network.

Third, at RP, AP-MLD 304 may transfer rate limiting state and replay detection state information to target AP-MLD 310. SN counter, PN counter, rate limiting and replay detection state information may collectively be referred to as network control information.

In one example, once target AP-MLD 310 has the SN counter and the PN counter sent by current AP-MLD 304, target AP-MLD 310 delivers DL data to UE 302 via DL 314.

In another example embodiment, the SN counter and the PN counter may be sent to target AP-MLD 304 before occurrence of the RP. In this instance, current AP-MLD 304 may increment the SN and PN counters by large enough number such that target AP-MLD 310 can safely use them to send DL data to UE 302 at the RP.

After the occurrence of the RP, the following steps may be implemented:

Current AP-MLD 304 discards all UL data from UE 302.

All new DL traffic that is still available at current AP-MLD 304 are transferred to target AP-MLD 310 (e.g., either via by current AP-MLD 304 or via a Wireless LAN Controller (WLC) that manages current AP-MLD 304 and target AP-MLD 310). This transfer may occur over a wired connection or a wireless connection to target AP-MLD 310. In another example, this transfer can be via MAC address learning that WLC implements using Control and Provisioning of Wireless Access Points (CAPWAP) tunnel.

Furthermore, after the occurrence of the RP, current AP-MLD 304 continues to deliver already queued DL MSDUs, A-MSDUs, and MPDUs to UE 302 until one or more of the following occurs:
(A) UE 302 notifies current AP-MLD 304 that UE 302 has terminated its connectivity to current AP-MLD 304. This can be a direct communication by UE 302 to current AP-MLD 304 or indirectly via target AP-MLD 310 using any known or to be developed signaling procedure(s);
(B) A timeout at current AP-MLD 304, where a duration of the timeout is longer than a threshold amount of time. The threshold amount of time may be a configurable parameter determined based on experiments and/or empirical studies;
(C) Target AP-MLD 310 indicates that target AP-MLD 310 has sent most of all 4096 frames (which may be equal to a size of the SN space) to UE 302 for a TID; and/or
(D) Target AP-MLD 310 reports that UE 302 has roamed to another AP-MLD that is different than current AP-MLD 304 or target AP-MLD 310.

Upon occurrence of one or more of (A)-(D), current AP-MLD 304 discards all DL state for UE 302.

After the RP, target AP-MLD 310 accepts UL data from UE 302 over UL 312. Upon receiving UL data, target AP-MLD 310 may queue the received UL data.

In some examples, once target AP-MLD 310 has rate limiting state and replay detection state information (sent by current AP-MLD 304 at the RP), target AP-MLD 310 can forward queued UL data to the network. In some examples, AP-MLD 310 may further introduce an additional delay to minimize the likelihood of mis-ordering within the network.

UE 302, striving to avoid mis-ordering of DL frames sent to upper layers yet simultaneously striving to not buffer DL frames received from target AP-MLD 310 overlong, may at some point abandon residual MSDUs queued at current AP-MLD 304 in order to send traffic from target AP-MLD 310 to upper layers. This “knife-switch” change can occur per flow spec/TID and be based on MSDU expiry times.

FIG. 4A illustrates an example process implemented based on the proposed roaming protocol described above, according to some aspects of the present disclosure. Various steps of FIG. 4B will be described with reference to FIG. 3 above. Furthermore, steps of FIG. 4A will be described from the perspective of current AP-MLD 304. It will be understood by those having ordinary skill in the art that current AP-MLD 304 may have one or more memories having computer-readable instructions stored thereon, and one or more processors configured to execute the computer-readable instructions to implement functionalities described with respect to each step of FIG. 4A.

Process 400 of FIG. 4A may be as follows.

At step 402, current AP-MLD 304 may set a roaming point (RP). The RP may be set as a triggering event and may be negotiated with UE 302 as described above.

At step 404, current AP-MLD 304 may deliver UE 302's UL data to the network prior to the RP or alternatively may hold the UL data until after the RP. The network may be a wireless network (e.g., Wi-Fi network) such as network 100 of FIG. 1. Such network may have a controller such as a WLC to which UL data of UE 302 may be delivered. Alternatively, UE 302's UL data may be delivered to an intended destination via the network.

At step 406, current AP-MLD 304 may flush the reorder buffer at current AP-MLD 304 to the network (e.g., to a WLC) before the RP.

Step 408 may optionally be implemented before the RP. If implemented, at step 408, current AP-MLD 304 may increment counters for SN and PN by a number sufficiently large to ensure that target AP-MLD 310 can use the same at the RP.

At step 410, current AP-MLD 304 may detect the RP. In other words, at step 410, RP may occur (e.g., as negotiated previously).

At step 412, current AP-MLD 304 may discard UL state information for UE 302 as described above.

Steps 414 and 416 may be optional and performed if step 408 is not performed. In other words, process 400 includes implementing step 408 or in the alternative, steps 414 and 416.

At step 414, current AP-MLD 304 may increment SN counter, PN counter for all queued data units (e.g., MSDUs, A-MSDUs, and MPDUs) for UE 302.

At step 416, current AP-MLD 304 may send SN counter and PN counters as incremented pay step 414 to target AP-MLD 310.

At step 418, current AP-MLD 304 may send rate limiting information and replay detection state information to target AP-MLD 310.

At step 420 and after the RP, current AP-MLD 304 discards all UL data from UE 302.

At step 422 and after the RP, current AP-MLD 304 may continue to transmit (send) DL data to UE 302 until one of a plurality of conditions occurs (is/are detected). The plurality of conditions may be the same as described above. For instance, the plurality of conditions include:
(A) UE 302 notifying current AP-MLD 304 that UE 302 has terminated its connectivity to current AP-MLD 304. This can be a direct communication by UE 302 to current AP-MLD 304 or indirectly via target AP-MLD 310 using any known or to be developed signaling procedure(s);
(B) A timeout at current AP-MLD 304, where a duration of the timeout is longer than a threshold amount of time. The threshold amount of time may be a configurable parameter determined based on experiments and/or empirical studies;
(C) Target AP-MLD 310 indicating that target AP-MLD 310 has sent most of all 4096 frames (which may be equal to a size of the SN space) to UE 302 for a TID; and/or
(D) Target AP-MLD 310 reporting that UE 302 has roamed to another AP-MLD that is different than current AP-MLD 304 or target AP-MLD 310.

At step 424, current AP-MLD 304 determines if one or more of the plurality of conditions has occurred. If not (NO at step 424), the process 400 reverts back to step 422 and current AP-MLD 304 continues to send DL data to UE 302 until one or more of the plurality of conditions occur.

Once current AP-MLD 304 determines (detects) that one or more of the plurality of conditions has/have occurred (YES at step 424), at step 426, current AP-MLD 304 discards DL states for UE 302. After this point, UE 302 may be served entirely by target AP-MLD 310.

FIG. 4B illustrates an example process implemented based on the proposed roaming protocol described above, according to some aspects of the present disclosure. Various steps of FIG. 4B will be described with reference to FIG. 3 above. Furthermore, steps of FIG. 4B will be described from the perspective of target AP-MLD 310. It will be understood by those having ordinary skill in the art that target AP-MLD 310 may have one or more memories having computer-readable instructions stored thereon, and one or more processors configured to execute the computer-readable instructions to implement functionalities described with respect to each step of FIG. 4B.

Process 450 of FIG. 4A may be as follows.

At step 452, target AP-MLD 310 may detect a RP. As noted above, a given RP may be known to current and target AP-MLDs as well as UEs (e.g., previously negotiated).

Once a RP is detected, at step 454, target AP-MLD 310 may start receiving DL data for UE 302 from the network (e.g., from WLC controller of the wireless network in which target AP-MLD 310 as well as current AP-MLD 304 and UE 302 operate.

Two of the plurality of conditions described above with reference to step 422, if occurred, occur at target AP-MLD 310. For instance, target AP-MLD 310 may detect that UE 302's connectivity to current AP-MLD 304 is terminated (e.g., UE 302 may inform target AP-MLD 310 of such termination). In response, target AP-MLD 310 may inform current AP-MLD 304 of such termination, accordingly. Other conditions, implemented at target AP-MLD 310, include sending most of 4096 frames to UE 302 and detecting roaming of UE 302 to a new AP-MLD that is different than current AP-MLD 304 and target AP-MLD 310.

Therefore, at step 456, target AP-MLD 310 determines if UE 302 sent an indication (e.g., a notification or a message) to target AP-MLD 310 that UE 302 is no longer connected to current AP-MLD 304.

If so (YES at step 456), the process proceeds to step 462 which will be described below.

If not (NO at step 456), then at step 458, target AP-MLD 310 determines if most of (e.g., more than 50%, 60%, 70%, 80%, 90%, 95%, etc.) of 4096 frames are sent to UE 302 as described above, and/or UE 302 has roamed to a new AP-MLD that is different than current AP-MLD 304 and target AP-MLD 310.

If not (NO at step 458), the process proceeds to step 462 which will be described below.

If one or both of conditions at step 458 occur (YES at step 458), then at step 460, target AP-MLD 310 may notify current AP-MLD 304 of the occurrence of the one or more conditions. This notification may in turn trigger current AP-MLD 304 to delete all DL states for UE 302 as described with reference to step 426 of FIG. 4A.

At step 462, target AP-MLD 310 may accept UL data for UE 302 and queue the same in one or more buffers at target AP-MLD 310.

At step 464, target AP-MLD 310 may receive SN and PN counters (e.g., updated by current AP-MLD 304 as described above) as well as rate limiting information and replay detection state information from current AP-MLD 304.

In one example, step 464 may occur at or before step 454.

At step 466, target AP-MLD 310 may deliver DL data to UE 302 (e.g., after current AP-MLD 304 deletes DL states for UE 302). In another example, some DL data may simultaneously be delivered to UE 302 by target AP-MLD 310 and current AP-MLD 304.

At step 468, target AP-MLD 310 may deliver UL data for UE 302 to the network (e.g., WLC of the wireless network). This step may occur once target AP-MLD 310 receives the rate limiting information and replay detection state information from current AP-MLD 304 as described above. In another example, AP-MLD 310 may introduce an additional delay to the rate limiting information and replay detection state information to minimize the likelihood of mis-ordering within the network, prior to sending the UL data of UE 302 to the network.

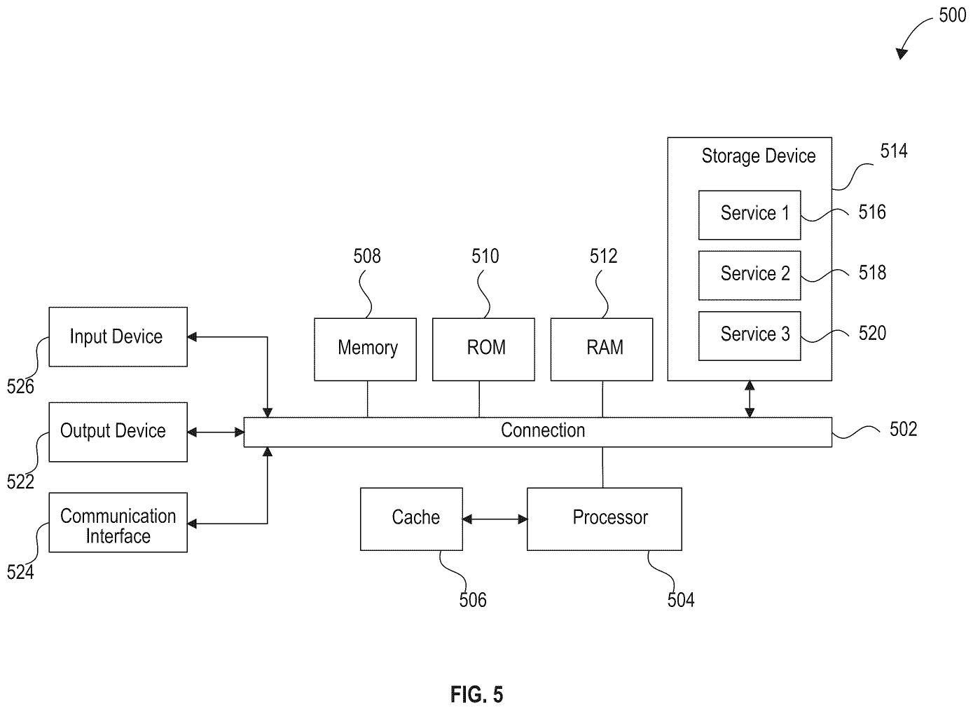

FIG. 5 shows an example of a system for implementing certain aspects of the present technology, according to some aspects of the present disclosure. FIG. 5 shows an example of computing system 500, which can be for example any computing device such as UE 302, AP MLD(s) and non-AP MLDs described and referenced in relation to FIGS. 1 through 4, and/or any other network component described above with reference to FIGS. 1-4. Components of example system 500 may be in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
detecting a roaming point, wherein,
the roaming point is an event that triggers a user equipment to switch connectivity from a first access point to a second access point, and
the user equipment, the first access point, and the second access point operate as multi-link devices;
maintaining, by the first access point, transmission of downlink data to the user equipment after the roaming point until one of a plurality of conditions occurs; and
discarding uplink traffic from the user equipment.

2. The method of claim 1, further comprising:
discarding uplink state information for the user equipment.

3. The method of claim 1, further comprising:
transferring network control information from the first access point to the second access point at the roaming point.

4. The method of claim 3, wherein the network control information includes a sequence number counter and a packet number counter for queued data units at the first access point, a rate limiting state information, and a replay detection state information.

5. The method of claim 1, wherein the plurality of conditions include:
receiving a notification from the user equipment that the user equipment has switched connectivity from the first access point to the second access point;
a timeout at the first access point that is longer than a threshold period;
receiving a notification from the second access point that the second access point has sent most or all of sequence number space to the user equipment for a traffic identifier; and
reporting, by the second access point, that the user equipment has roamed to a new access point that is different from the first access point or the second access point.

6. The method of claim 1, further comprising:
flushing, prior to the roaming point, a reorder buffer of the first access point to a network controller of a network in which the user equipment, the first access point, and the second access point operate.

7. The method of claim 1, further comprising:
prior to the roaming point, incrementing a sequence number counter and a packet number counter for queued data units at the first access point; and
sending the sequence number counter and the packet number counter to the second access point after incrementing the sequence number counter and the packet number counter.

8. An access point comprising:
one or more memories having computer-readable instructions stored therein; and
one or more processors configured to execute the computer-readable instructions to:
detect a roaming point, wherein,
the access point is a first access point,
the roaming point is an event that triggers a user equipment to switch connectivity from the first access point to a second access point, and
the user equipment, the first access point, and the second access point operate as multi-link devices;
maintain, by the first access point, transmission of downlink data to the user equipment after the roaming point until one of a plurality of conditions occurs; and
discard uplink traffic from the user equipment.

9. The access point of claim 8, wherein the one or more processors are further configured to execute the computer-readable instructions to discard uplink state information for the user equipment.

10. The access point of claim 8, wherein the one or more processors are further configured to execute the computer-readable instructions to transfer network control information from the first access point to the second access point at the roaming point.

11. The access point of claim 10, wherein the network control information includes a sequence number counter and a packet number counter for queued data units at the first access point, a rate limiting state information, and a replay detection state information.

12. The access point of claim 8, wherein the plurality of conditions include:
receiving a notification from the user equipment that the user equipment has switched connectivity from the first access point to the second access point;
a timeout at the first access point that is longer than a threshold period;
receiving a notification from the second access point that the second access point has sent most or all of sequence number space to the user equipment for a traffic identifier; and
reporting, by the second access point, that the user equipment has roamed to a new access point that is different from the first access point or the second access point.

13. The access point of claim 8, wherein the one or more processors are further configured to execute the computer-readable instructions to flush, prior to the roaming point, a reorder buffer of the first access point to a network controller of a network in which the user equipment, the first access point, and the second access point operate.

14. The access point of claim 8, wherein the one or more processors are further configured to execute the computer-readable instructions to:
prior to the roaming point, increment a sequence number counter and a packet number counter for queued data units at the first access point; and
send the sequence number counter and the packet number counter to the second access point after incrementing the sequence number counter and the packet number counter.

15. One or more non-transitory computer-readable media comprising computer-readable instructions, which when executed by one or more processors of an access point, cause the access point to:
detect a roaming point, wherein,
the access point is a first access point,
the roaming point is an event that triggers a user equipment to switch connectivity from the first access point to a second access point, and
the user equipment, the first access point, and the second access point operate as multi-link devices;
maintain, by the first access point, transmission of downlink data to the user equipment after the roaming point until one of a plurality of conditions occurs; and
discard uplink traffic from the user equipment.

16. The one or more non-transitory computer-readable media of claim 15, wherein execution of the computer-readable instructions further cause the first access point to discard uplink state information for the user equipment.

17. The one or more non-transitory computer-readable media of claim 15, wherein execution of the computer-readable instructions further cause the first access point to transfer network control information from the first access point to the second access point at the roaming point.

18. The one or more non-transitory computer-readable media of claim 17, wherein the network control information includes a sequence number counter and a packet number counter for queued data units at the first access point, a rate limiting state information, and a replay detection state information.

19. The one or more non-transitory computer-readable media of claim 15, wherein the plurality of conditions include:
receiving a notification from the user equipment that the user equipment has switched connectivity from the first access point to the second access point;
a timeout at the first access point that is longer than a threshold period;
receiving a notification from the second access point that the second access point has sent most or all of sequence number space to the user equipment for a traffic identifier; and
reporting, by the second access point, that the user equipment has roamed to a new access point that is different from the first access point or the second access point.

20. The one or more non-transitory computer-readable media of claim 15, wherein execution of the computer-readable instructions further cause the first access point to:
prior to the roaming point, increment a sequence number counter and a packet number counter for queued data units at the first access point; and
send the sequence number counter and the packet number counter to the second access point after incrementing the sequence number counter and the packet number counter.
